(19) United States
(12) Patent Application Publication
(10) Pub. No.: US 2024/0423855 A1
(43) Pub. Date: Dec. 26, 2024

(54) Individual Lifting and Transporting Device and Method of Use

(71) Applicant: Robert Myers, Early, TX (US)

(72) Inventor: Robert Myers, Early, TX (US)

(21) Appl. No.: 18/418,423

(22) Filed: Jan. 22, 2024

Related U.S. Application Data
(60) Provisional application No. 63/509,046, filed on Jun. 20, 2023.

(51) Int. Cl. A61G 7/10

(52) U.S. Cl. CPC A61G 7/1051

(57) ABSTRACT

An ergonomic lifting aid device designed for safely transporting individuals is disclosed. The device includes a planar, rectangular main body made from high-grade, durable material such as nylon or polyester. The main body has a selectively attachable flap at the bottom end thereof, which can be detached and reattached using a hook and loop type strap, facilitating easy positioning under an individual without necessitating lifting while also providing support to the legs of the individual. A gap portion in the main body accommodates the buttocks of the individual, ensuring stability and safety. The device is equipped with a plurality of straps, each strap forming handholds for assistants/aids/transporters to grip the device during transportation. A plurality of longitudinal straps are sewn to the straps to reinforce the handholds, thereby enhancing the strength and durability of the device.

### CROSS-REFERENCE TO RELATED APPLICATION

The present application claims priority to, and the benefit of, U.S. Provisional Application No. 63/509,046, which was filed on Jun. 20, 2023, and is incorporated herein by reference in its entirety.

### FIELD OF THE INVENTION

The present invention generally relates to the field of individuals transporting devices. More specifically, the present invention relates to a novel individual lifting and transporting aid device designed for safely transporting individuals. The device features a main body. The main body has an selectively attachable flap at the bottom end thereof, which can be detached and reattached using a hook and loop type strap, providing support to the legs of the individual. A gap portion in the main body accommodates the buttocks of the individual, ensuring stability and safety. The device is equipped with a plurality of straps, each strap forming handholds for assistants to grip the device during transportation. Accordingly, the present disclosure makes specific reference thereto. Nonetheless, it is to be appreciated that aspects of the present invention are also equally applicable to other like applications, devices, and methods of manufacture.

### BACKGROUND

By way of background, people who are injured or have fallen down need assistance from other people to get up or move from one place to another. Even patients at healthcare centers, who are critical and/or lack physical dexterity, usually need support from other people/helpers to move from a bed to a wheelchair/stretcher or vice versa.

Further, in a situation where a person has fallen and is unable to get up from the floor, the individual may sustain injuries to shoulders and ribs if the injured person is lifted by their arms or are gripped around their chest. This situation may deteriorate the condition of the injured person. Further, while shifting a patient from the bed to the wheelchair/stretcher, the people assisting in moving the patient may lose their grip and the patient may be accidentally dropped and can become more injured. Furthermore, if the patient is not supported adequately while moving them from the bed to the stretcher, or from the stretcher to the bed, then the patient may sustain injuries in the chest, shoulders, or other parts of the body. Apart from the suffering of the injured person, the hospital staff or nursing home aids may become injured as well while shifting patients from one place to another. Staff/aids may need assistance of other patient lifting devices to safely transfer the patients or injured person from one place to another.

Various kinds of patient transfer devices such as transfer belts, lifts, and other similar equipment are commercially available. However, the conventional transfer belts are not rigid and do not provide a strong grip to the helpers. Such devices can break while lifting and transferring an individual, in which case the individual may sustain additional injuries, thereby causing unbearable trauma to the patient. Further, in the state of the art, devices such as patient hoists are also used to move patient from the bed to the wheelchair or vice-versa, however, the patient hoist devices remain ineffective in moving the patient for a longer distance. For example, in emergency situations such as disaster relief operations, the patient hoist device becomes useless.

Therefore, there exists a long felt need in the art for an individual lifting device for transferring an individual from one place to another. Additionally, there is a long felt need in the art for a patient lifting device that is rigid and ensures proper safety of the patient. Moreover, there is a long felt need in the art for a lifting device that can be used to assist patients, injured persons, or elderly individuals to move from the bed to the wheelchair or vice versa in a safe manner. Further, there is a long felt need in the art for an individual lifting device that prevents the patient from becoming accidentally dropped or being subjected to additional trauma by providing strong and stable handholds for gripping. Furthermore, there is a long felt need in the art for a patient lifting device that can be used in emergency situations such as medical emergencies or disaster relief operations, to move the injured person or elderly individual for a longer distance. Finally, there is a long felt need in the art for a patient lifting device that is safe, efficient, and ensures smooth and safe transition of injured persons.

The subject matter disclosed and claimed herein, in one embodiment thereof, comprises an individual lifting and transporting aid device. The device features a planar main body made from a durable material, having a generally rectangular shape. A handle flap at the bottom end of the main body is adapted to being selectively unattached from one side edge of the main body and reattached using a fastening mechanism such as a hook and loop type strap. A gap portion in the main body is designed to accommodate the buttocks of a person, ensuring safety and stability during lifting. The device includes a plurality of straps sewn along the width of the main body to form a plurality of handholds, enabling for various gripping positions by assistants, thereby reducing the risk of slippage and enhancing the safety of the lifting process. The straps are sewn to the main body and are further reinforced using additional longitudinal straps.

In this manner, the individual lifting and transferring device of the present invention accomplishes all of the forgoing objectives and provides users with an ergonomically designed device to minimize physical stress on both the individual being moved and the assistants doing the moving. The device is compact and highly portable and made from high-grade nylon or polyester. The handholds allow two to six people to participate in the lifting process, adaptable for different situations and needs. The device using the selectively attachable flap obviates the need to physically lift or roll an individual onto the device, thereby reducing the risk of causing or exacerbating injury. The device can be used in both a domestic situation, such as assisting the elderly or disabled, and in an emergency scenario such as medical emergencies or disaster relief operations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mobility afflicted person lifting aid device. The device further comprises a planar main body made from a durable material, having a generally rectangular shape with adjustable dimensions suitable for lifting and transporting individuals of various sizes and weights. A handle flap at the bottom end of the main body is adapted to being selectively unattached from one side edge of the main body and reattached using a fastening mechanism such as a hook and loop type strap. A gap portion in the main body is designed to accommodate the buttocks of a person, ensuring safety and stability during lifting. The device includes a plurality of straps which form a plurality of handholds, enabling for various gripping positions by assistants, thereby reducing the risk of slippage and enhancing the safety of the lifting process.

In another aspect, a lifting and transporting aid device for an individual is disclosed. The device includes a rear surface and a front surface, the front surface has a plurality of straps sewn thereon, each strap forms a pair of handholds on the opposite ends. The handholds are positioned along a height of the device for case of lifting by multiple helpers. The plurality of the straps are reinforced using a pair of longitudinal straps along one side edge of the device and another pair of the longitudinal straps along the other side of the device. The device includes a chest strap in the form of a pair of hook and loop strap for additional support of the lifted individual, providing enhanced security and comfort.

In yet another embodiment, an individual lifting device is disclosed. The device includes a main body incorporating a planar surface suitable for both sitting and lying positions of the individual and for accommodating different emergency and non-emergency scenarios. A detachable and attachable flap designed to support the legs of the individual is included and can be slid under the person without the need for initial lifting. A plurality of handholds formed by straps are included in the device, enabling for various gripping positions by assistants/aids, thereby reducing the risk of slippage and enhancing the safety of the lifting process.

In yet another aspect of the present invention, a method for lifting and transporting an individual using a lifting aid device is described. The method comprises the steps of providing the device, the device includes a planar surface, a selectable detachable and attachable flap designed to support the legs of the individual and a plurality of handholds formed by straps for gripping the device. The method further includes positioning the lifting aid device underneath the individual to be lifted, adjusting the main body to align with the body of the individual, placing the buttocks within a designated gap portion of the main body for secure seating, detaching a handle flap located at the bottom end of the main body from one side edge and sliding it under the legs of the individual, fastening the handle flap back to the main body using a hook and loop type strap, thereby securing the legs of the individual for transportation, and utilizing multiple straps forming handholds located on the front surface of the planar surface to grasp the handholds to lift and transport the individual.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the person lifting aid device of the present invention in accordance with the disclosed architecture;

FIG. 2 illustrates a front perspective view of the individual lifting and transporting aid device of the present invention in accordance with the disclosed structure;

FIG. 3 illustrates another view of the individual lifting and transferring device of the present invention with the handle flap unattached from one side edge in accordance with the disclosed structure;

FIG. 4 illustrates a perspective view showing the lifting device of the present invention is used for lifting and carrying an individual in accordance with the disclosed structure;

FIG. 5 illustrates a flow diagram depicting a process of use of the lifting aid device of the present invention for lifting and transporting an individual in accordance with the disclosed structure;

FIG. 6 illustrates a perspective view of another embodiment of the person lifting aid device of the present invention in accordance with the disclosed architecture; and

FIG. 7 is an enlarged view of the selectively securable handle flap to the main body of the person lifting aid device as shown in FIG. 6.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an individual lifting device for transferring an individual from one place to another. Additionally, there is a long felt need in the art for a patient lifting device that is rigid and ensures proper safety of the patients. Moreover, there is a long felt need in the art for a lifting device that can be used to assist patients, injured persons, mobility challenged, or elderly individuals to move from the bed to the wheelchair or vice versa in a safe manner. Further, there is a long felt need in the art for an individual lifting device that prevents the patient from accidentally being dropped or subjected to additional trauma by providing strong and stable handholds for gripping. Furthermore, there is a long felt need in the art for a patient lifting device that can be used in emergency situations such as medical emergencies or disaster relief operations, to move the injured person or elderly individual for a longer distance. Finally, there is a long felt need in the art for a patient lifting device that is safe, efficient, and ensures smooth and safe transition of injured people.

The present invention, in one exemplary embodiment, describes is a method for lifting and transporting an individual using a lifting aid device. The method comprises the steps of providing the device, the device includes a planar surface, a detachable flap designed to support the legs of the individual and a plurality of handholds formed by straps for gripping the device. The method further includes positioning the lifting aid device underneath the individual to be lifted, adjusting the main body to align with the body of the individual, placing the buttocks within a designated gap portion of the main body for secure seating, detaching a handle flap located at the bottom end of the main body from one side edge and sliding it under the legs of the individual, fastening the handle flap back to the main body using a hook and loop type strap, thereby securing the legs of the individual for transportation, and utilizing multiple straps forming handholds located on the front surface of the planar surface to grasp the handholds to lift and transport the individual.

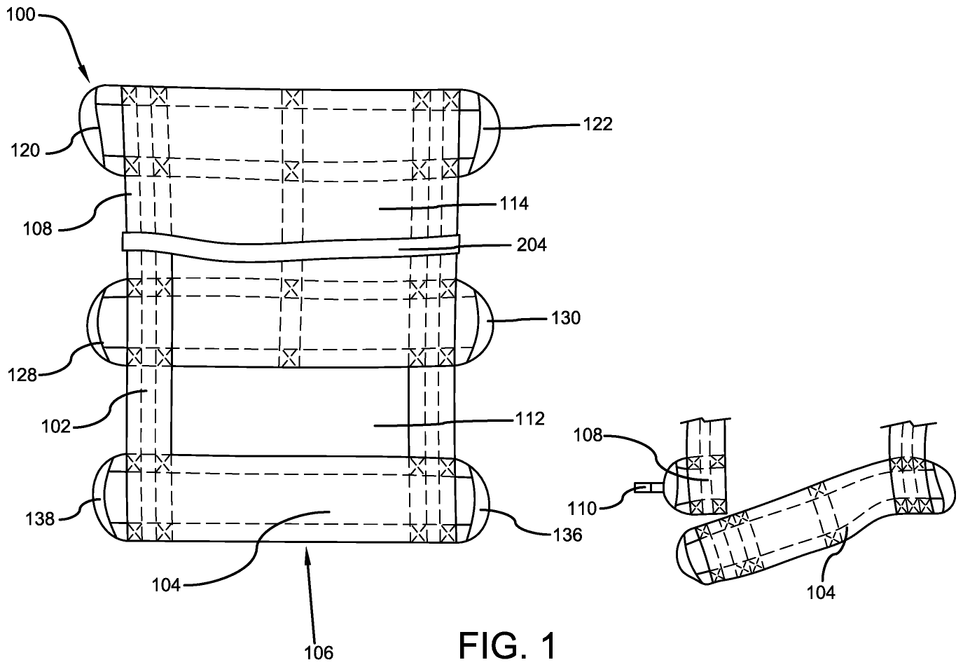

Referring initially to the drawings, FIG. 1 illustrates a perspective view of the person lifting aid device of the present invention in accordance with the disclosed architecture. The person lifting aid device 100 of the present invention is an ergonomic device designed for transporting individuals in both emergency and non-emergency situations while minimizing the physical strain on both the individual being moved and the helpers/aids moving the individual. More specifically, the individual lifting aid device 100 has a planar main body 102 which is generally rectangular having a width (Arrow A) from about 24 inches to about 30 inches and a height (Arrow B) from about 36 inches to about 42 inches to lift and transport individuals of different sizes and weights. Preferably, the width is about 28 inches and the height is about 39 inches. The main body 102 is made from a high-grade, robust material such as nylon or polyester. Further, the main body 102 is wear resistance and has the ability to bear substantial weight without tearing or deforming.

The main body 102 includes a selectively attachable flap or handle flap 104 which forms the bottom end 106 of the main body 102. The handle flap 104 is adapted to be selectively attachable from a side edge 108 of the main body 102 and can be selectively attached or fastened to the main body 102 using a hook and loop type strap 110. As described later in the disclosure, the flap 104 can be slid under a person without needing to lift the person, thereby reducing the risk of further injury to the lifted person and reducing the risk of injury to the helper/aid. A portion 112 of the main body 102 includes an area without the material and functions as a gap for accommodating the butt of a person lifted using the lifting aid device 100. The gap portion 112 has a height of about four to six inches, thereby preventing the person from falling therethrough.

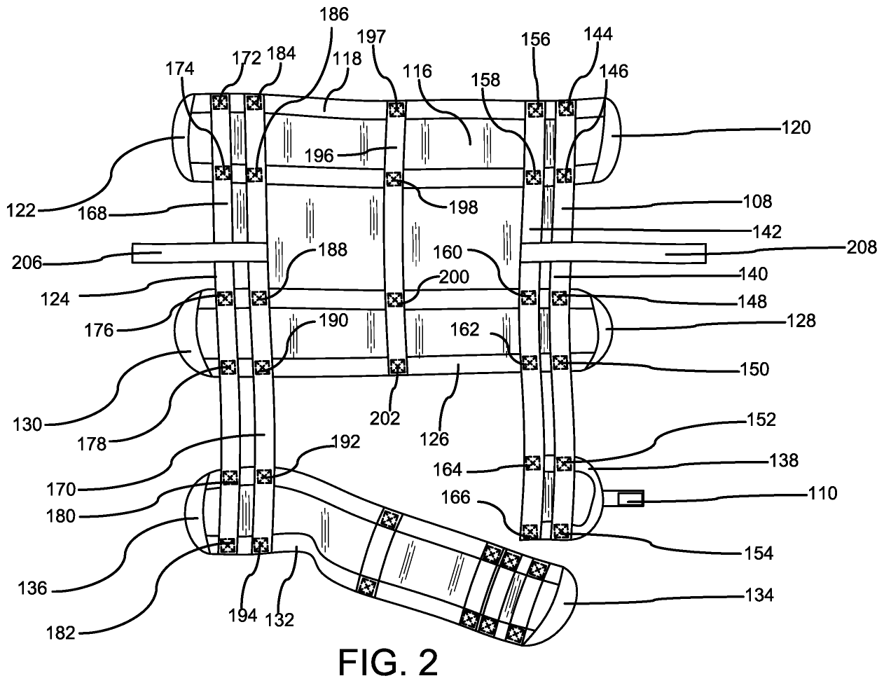

A person who is lifted using the device 100 lies or sits on the rear surface 114 of the main body 102 and the front surface 116 (shown in FIG. 2) has a plurality of straps forming handholds for lifting the person using the lifting aid device 100.

FIG. 2 illustrates a front perspective view of the individual lifting and transporting aid device 100 of the present invention in accordance with the disclosed structure. The front surface 116 includes a first strap 118 forming a first pair of handholds 120, 122 on both sides 108, 124 of the main body 102. The first strap 118 forms a closed loop on the front surface 116 and forms the handholds 120, 122. Similarly, a second strap 126 forms a second pair of handholds 128, 130. A third strap 132 is sewn along the periphery of the selectively attachable flap 104 and forms a pair of handholds 134, 136. The handhold 136 is designed to be in alignment with the handhold 138 which is separately sewn to the front surface 116 of the main body 102. The handhold 138 has the attached hook and loop type strap 110 which is used for selectively attaching, fastening, or securing flap 104 to side edge 108 of the main body 102.

For reinforcing the handholds 120, 128, 138 to the main body 102, additional longitudinal straps 140, 142 are used and are sewn to the straps 118, 126. As illustrated, the longitudinal strap 140 is sewn along the side edge 108 and to the strap 118 at sewn points 144, 146, to the strap 126 at sewn points 148, 150 and to the handhold 138 at sewn points 152, 154. Similarly, the longitudinal strap 142 is sewn to the strap 118 at sewn points 156, 158, to the strap 126 at sewn points 160, 162 and to the handhold 138 at sewn points 164, 166.

The main body 102 has a pair of longitudinal straps 168, 170 for reinforcing the handholds 122, 130, 136. The longitudinal strap 168 is sewn to the strap 118 at sewn points 172, 174, to the strap 126 at the sewn points 176, 178 and to the strap 132 at sewn points 180, 182. Similarly, the longitudinal strap 170 is sewn to the strap 118 at sewn points 184, 186, to the strap 126 at sewn points 188, 190, and to the strap 132 at sewn points 192, 194.

A central strap 196 is sewn to the strap 118 at sewn points 197, 198, and to the second strap 126 at sewn points 200, 202. A chest strap 204 is provided to provide additional support to the lifted individual. The chest strap 204 includes a first hook and loop type strap 206 and a second hook and loop type strap 208 that are looped through the rear surface 114 to fasten along the chest of the accommodating individual. The straps 206, 208 are each 24 inches long and provide additional security to an individual lifted using the lifting device 100.

Each strap sewn to the main body 102 is from about 1.0″ to about 3.0″ wide for providing adequate support to the lifting user and helpers lifting the user. The longitudinal straps 140, 142 have a gap of about 1″ therebetween and similarly, the longitudinal straps 168, 170 have a constant gap of about 1″ therebetween.

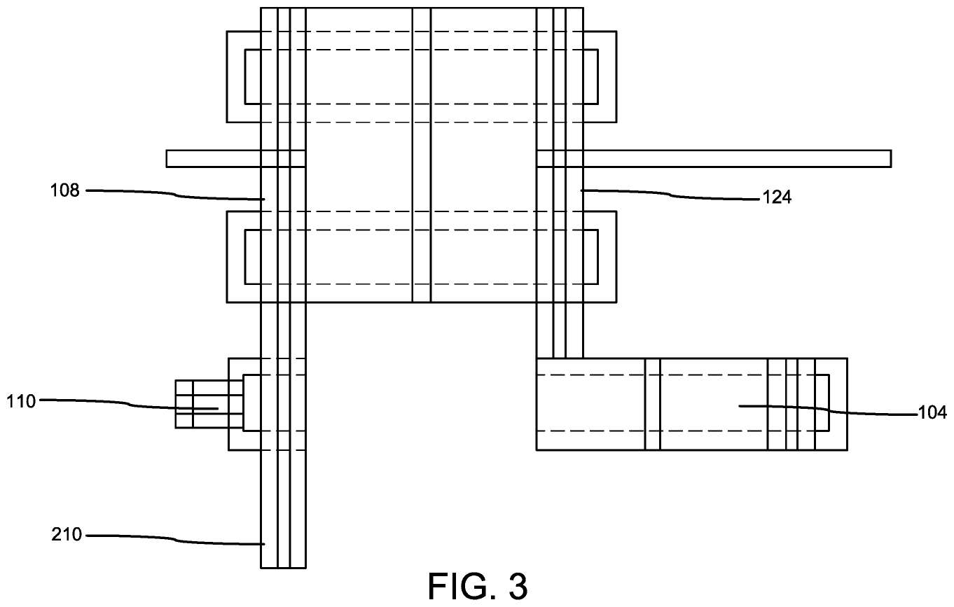

FIG. 3 illustrates another view of the individual lifting and transferring device of the present invention with the handle flap 104 initially unattached on one side edge 108 in accordance with the disclosed structure. The handle flap 104 is attached to the side edge 124 of the main body 102 and is slid under the legs of an individual and is then selectively fastened to the other side edge 108 using the hook and loop type strap 110. In the present embodiment, an extended flap 210 is included which can be folded up to cover a portion of the side edge 108 to create a loop for the handle flap 104 to come through.

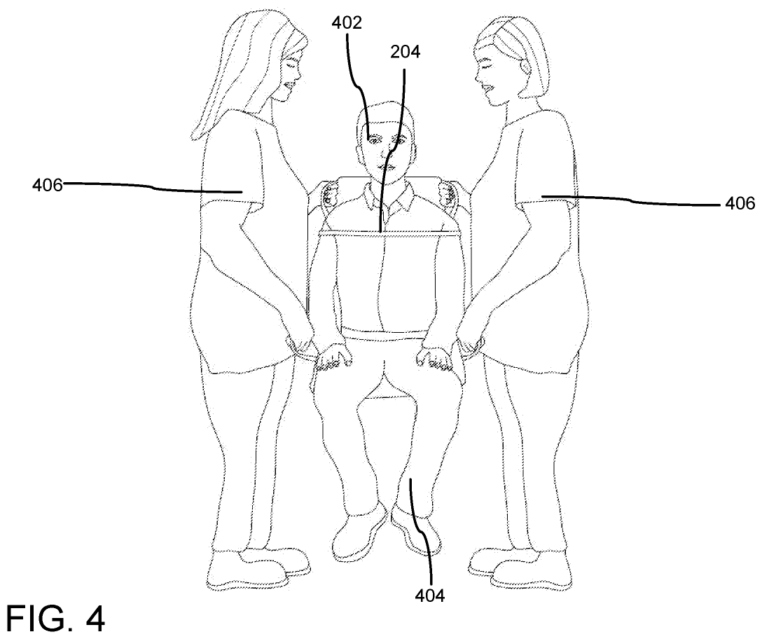

FIG. 4 illustrates a perspective view showing the lifting device of the present invention is used for lifting and carrying an individual in accordance with the disclosed structure. The individual 402 can be lifted by two to six helpers, aids, or assistants 406 who hold one or more handholds 120, 122, 128, 130, 134, 138. The flap 104 provides the support to the legs 404 and the gap portion 112 as described earlier enables the individual 402 to easily sit and accommodate in the device 100. The main body 102 conforms to the concave shape of the back of the individual 402 when the individual 402 sits in the device 100. The device 100 eliminates the requirement of lifting the user 402 and making the user 402 sit on a chair. The handholds 120, 122, 128, 130, 134, 138 provide adequate grip and support to the assistants 406, thereby eliminating slipping and falling of the individual 402.

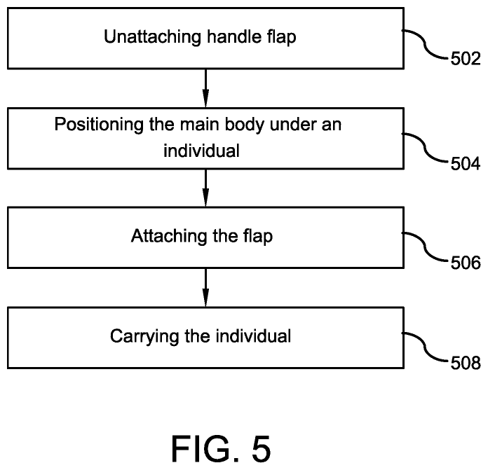

FIG. 5 illustrates a flow diagram depicting a process of use of the lifting aid device of the present invention for lifting and transporting an individual in accordance with the disclosed structure. Initially, the handle flap 104 is unattached from side edge 108 and positioned in the unattached position as illustrated in FIG. 3 (Step 502). Then, the main body 102 is made planar by extending all the edges and is positioned under an individual such that the butt of the individual is positioned in the gap portion 112 (Step 504). Thereafter, the flap 104 is attached to the main body 102 to support the legs of the user using the hook and loop strap 110 (Step 506). Finally, the user is carried safely by holding the handholds of the device (Step 508).

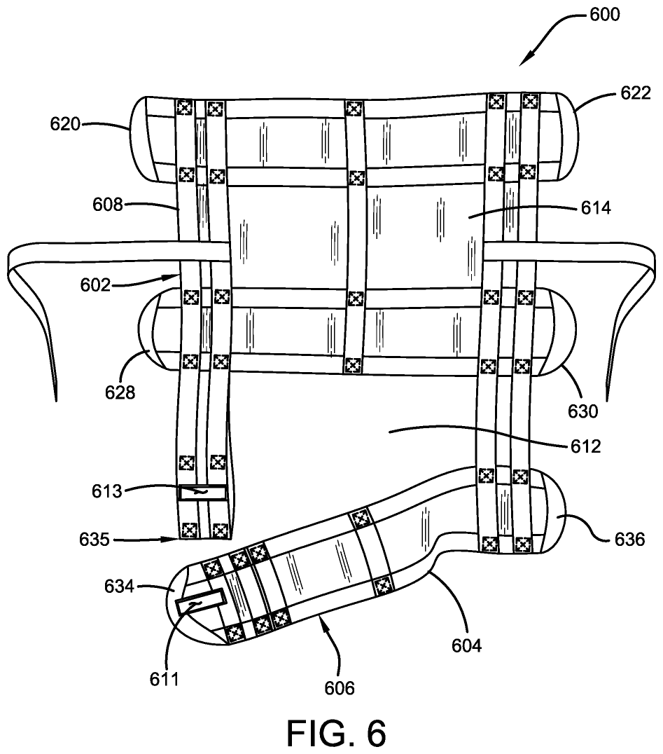

FIG. 6 illustrates a perspective view of another embodiment of the person lifting aid device of the present invention in accordance with the disclosed architecture. The person lifting aid device 600 of the present invention is an ergonomic device designed for transporting individuals in both emergency and non-emergency situations while minimizing the physical strain on both the individual being moved and the helpers/aids moving the individual. More specifically, the individual lifting aid device 600 has a planar main body 602 which is generally rectangular. The main body 602 can be made from a high-grade, robust material such as nylon or polyester. Further, the main body 602 is wear resistance and has the ability to bear substantial weight without tearing or deforming.

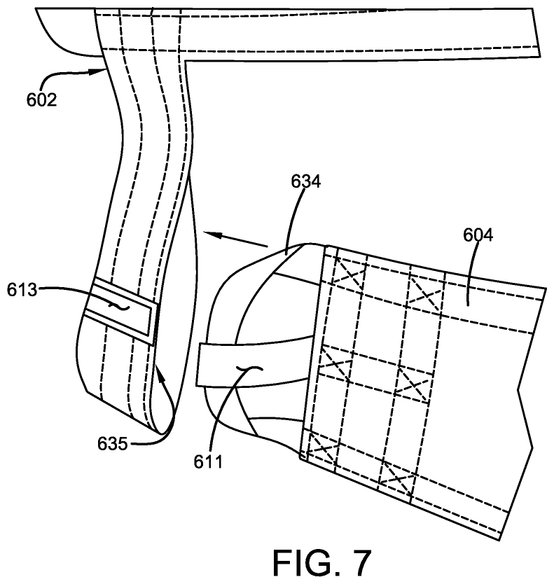

The main body 602 includes a selectively attachable flap or handle flap 604 which forms the bottom end 606 of the main body 602. The handle flap 604 is adapted to be selectively attachable from a side edge 608 of the main body 602 and can be selectively attached or fastened to the main body 602 using a hook and loop type strap 611, 613, after inserting handle 634 through a loop 635 (refer to FIG. 7). Similar to the description above, the flap 604 can be slid under a person without needing to lift the person, thereby reducing the risk of further injury to the lifted person, and reducing the risk of injury to the helper/aid. A portion 612 of the main body 602 includes an area without the material and functions as a gap for accommodating the butt of a person lifted using the lifting aid device 600.

A person who is lifted using the device 600 lies or sits on the rear surface 614 of the main body 602 and the front surface has a plurality of straps 620, 622, 628, 630, 634, 636 forming handholds for lifting the person using the lifting aid device 600.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “lifting aid device”, “individual lifting aid device”, “person lifting aid device”, “individual lifting and transporting aid device”, and “device” are interchangeable and refer to the individual lifting and transporting aid device 100 of the present invention.

Notwithstanding the forgoing, the individual lifting and transporting aid device 100 of the present invention can be of any suitable size and configuration as is known in the art without affecting the overall concept of the invention, provided that it accomplishes the above stated objectives. One of ordinary skill in the art will appreciate that the individual lifting and transporting aid device 100 as shown in the FIGS. are for illustrative purposes only, and that many other sizes and shapes of the individual lifting and transporting aid device 100 are well within the scope of the present disclosure. Although the dimensions of the individual lifting and transporting aid device 100 are important design parameters for user convenience, the individual lifting and transporting aid device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lifting aid device for lifting an individual, the lifting aid device comprising:
a planar main body having a rectangular shape including a first side edge extending from a top end to a bottom end, and a second side edge extending from said top end to said bottom end;
a selectively attachable handle flap;
a first strap; and
a second strap;
wherein said handle flap forming a bottom edge of said planar main body including a first end selectively attachable to said first side edge and a second end connected to said second side edge;
wherein said first strap having a first handle extending outward from said first side edge and an opposing second handle extending outward from said second side edge;
wherein said second strap having a third handle extending outward from said first side edge and an opposing fourth handle extending outward from said second side edge;
wherein said handle flap having a fifth handle extending outward from said first side edge and an opposing sixth handle extending outward from said second side edge;
wherein said second strap, said handle flap, said first side edge, and said second side edge defining an open gap therebetween of said planar main body;
wherein said gap accommodates a buttocks of a person lifted in said lifting aid device; and
further wherein said first handle, said second handle, said third handle, said fourth handle, said fifth handle, and said sixth handle providing a selective four hand holds for at least two individuals to lift the person in said lifting device.

2. The lifting aid device for lifting an individual of claim 1, wherein the person lifted in said lifting device is selectively lying or sitting.

3. The lifting aid device for lifting an individual of claim 2, wherein said first handle, said second handle, said third handle, said fourth handle, said fifth handle, and said sixth handle providing a selective six hand holds for at least four individuals to lift the person in said lifting device.

4. The lifting aid device for lifting an individual of claim 2, wherein said first handle, said second handle, said third handle, said fourth handle, said fifth handle, and said sixth handle providing a selective six hand holds for six individuals to lift the person in said lifting device.

5. The lifting aid device for lifting an individual of claim 2, wherein said first side edge having a hook and loop fastener for selectively attaching said first end of said handle flap to said first side edge.

6. The lifting aid device for lifting an individual of claim 2, wherein said gap having a height from four inches to six inches.

7. The lifting aid device for lifting an individual of claim 6, wherein said first strap forming a top edge of said planar main body.

8. The lifting aid device for lifting an individual of claim 7, wherein said planar body having a width from 24 inches to 30 inches and a height from 36 inches to 42 inches.

9. The lifting aid device for lifting an individual of claim 8, wherein said planar body having a width from 27 inches to 29 inches and a height from 38 inches to 40 inches.

10. The lifting aid device for lifting an individual of claim 7, wherein said planar main body having a material selected from the group consisting of a nylon and a polyester.

11. A lifting aid device for lifting an individual, the lifting aid device comprising:
a planar main body having a rectangular shape including a first side edge extending from a top end to a bottom end, and a second side edge extending from said top end to said bottom end;
a selectively attachable handle flap;
a first strap; and
a second strap;
wherein said handle flap forming a bottom edge of said planar main body including a first end selectively attachable to said first side edge and a second end connected to said second side edge;
wherein said first strap having a first handle extending outward from said first side edge and an opposing second handle extending outward from said second side edge;
wherein said second strap having a third handle extending outward from said first side edge and an opposing fourth handle extending outward from said second side edge;
wherein said handle flap having a fifth handle and an opposing sixth handle extending outward from said second side edge;
wherein said second strap, said handle flap, said first side edge, and said second side edge defining an open gap therebetween of said planar main body;
wherein said gap accommodates a buttocks of a person lifted in said lifting aid device; and
wherein said first handle, said second handle, said third handle, said fourth handle, said fifth handle, and said sixth handle providing a selective four hand holds for at least two individuals to lift the person in said lifting device.

12. The lifting aid device for lifting an individual of claim 11, wherein said first side edge having a seventh handle extending outward from said first side edge;
wherein said fifth handle aligned with said seventh handle when said handle flap selectively attached to said first side edge;
wherein said first side edge having a hook and loop fastener for selectively attaching said first end of said handle flap to said first side edge; and
further wherein said fifth handle and said seventh handle used it tandem to lift the person in said lifting device.

13. The lifting aid device for lifting an individual of claim 12, wherein the person lifted in said lifting device is selectively lying or sitting.

14. The lifting aid device for lifting an individual of claim 11, wherein said fifth handle insertable through a loop in said first side edge and securable to said first side edge with a hook and loop fastener; and
further wherein said first handle, said second handle, said third handle, said fourth handle, said fifth handle, and said sixth handle providing a selective six hand holds for at least four individuals to lift the person in said lifting device.

15. The lifting aid device for lifting an individual of claim 14, wherein said first strap forming a top edge of said planar main body.

16. The lifting aid device for lifting an individual of claim 15, wherein said planar main body having a material selected from the group consisting of a nylon and a polyester.

17. The lifting aid device for lifting an individual of claim 16, further comprising a chest strap having at least one hook and loop fastener for securing around the person in said lifting device, wherein the person is secured between said chest strap and said planar main body.

18. A method of lifting an individual with a lifting aid device, the method comprising the steps of:
providing a planar main body having a rectangular shape including a first side edge extending from a top end to a bottom end, and a second side edge extending from said top end to said bottom end; a selectively attachable handle flap; a first strap; and a second strap; wherein said handle flap forming a bottom edge of said planar main body including a first end selectively attachable to said first side edge and a second end connected to said second side edge;
extending a first handle of said first strap outward from said first side edge and extending an opposing second handle of said first strap outward from said second side edge;
extending a third handle of said second strap outward from said first side edge and extending an opposing fourth handle of said second strap outward from said second side edge;
providing a fifth handle to said handle flap and extending a sixth handle of said handle flap outward from said second side edge;
sliding said planar main body under a person to be lifted in said lifting device;
sliding said handle flap under the legs of the person to be lifted in said lifting device;
aligning said fifth handle with a loop in said first side edge;
pulling said fifth handle through said loop, wherein said handle flap selectively attached to said first side edge, further wherein said second strap, said handle flap, said first side edge, and said second side edge defining an open gap therebetween of said planar main body, further wherein said gap accommodates a buttocks of the person lifted in said lifting aid device;
selectively grasping at least two of said first handle, said second handle, said third handle, and said fourth handle with at least two individuals lifting the person in said lifting device;
grasping said fifth handle with one hand of one individual lifting the person in said lifting device; and
grasping said sixth handle with one hand of another individual lifting the person in said lifting device.

19. The method of lifting an individual with a lifting aid device of claim 18, wherein said first side edge having a hook and loop fastener for selectively attaching said first end of said handle flap to said first side edge.

20. The lifting aid device for lifting an individual of claim 18, wherein said first handle, said second handle, said third handle, said fourth handle, said fifth handle, and said sixth handle providing a selective six hand holds for at least four individuals for lifting the person in said lifting device.
